(19) United States
(12) Patent Application Publication
(10) Pub. No.: US 2026/0048649 A1
(43) Pub. Date: Feb. 19, 2026

(54) ELECTRIC BICYCLE WITH DRIVE BATTERY ASSEMBLY AND DRIVE BATTERY ASSEMBLY FOR AN ELECTRIC BICYCLE

(71) Applicant: Smartscale NewCo AG, Huttwil (CH)

(72) Inventors: Lingfei HE, Babenhausen (DE); Naggy HENDO, Safenwil (CH); Yunlei MA, Shanghai (CN)

(73) Assignee: Smartscale NewCo AG, Huttwil (CH)

(21) Appl. No.: 19/300,058

(22) Filed: Aug. 14, 2025

(30) Foreign Application Priority Data
Aug. 14, 2024 (DE) 202024104592.0

(51) Int. Cl. B60K 1/04; B60L 50/60

(52) U.S. Cl. CPC B60K 1/04; B60L 50/66; B60K 2001/0461; B60K 2001/0488; B60K 2001/0494; B60L 2200/12

(57) ABSTRACT

The invention pertains to an electric bicycle (1) comprising a bicycle frame (2) and at least one battery assembly (8) having a drive battery (6), wherein the drive battery (6) comprises a fastening device (12) for detachable fastening to a frame-side holder (10) with a fastening projection (14), characterized in that a receptacle (20) of the drive battery (6) can be brought into engagement with the fastening projection (14) of the holder (10) in such a manner that the drive battery (6) can be pivoted into the holder (10) about the fastening projection (14) and can be locked by means of a latching lever (22).

Electric bicycles, so-called e-bikes, with electric motor assistance are known from the state of the art, which, in addition to a main battery, have an auxiliary battery to increase the range. The auxiliary battery can be attached to a frame-side holder on a frame tube, such as preferably an upper, lower or seat tube of the bicycle frame. The holder can be attached to the attachment points of a water bottle holder, for example. In such systems, the auxiliary battery is inserted and locked into the frame-side holder, particularly from above or below. In alternative battery assemblies, the auxiliary battery is inserted into the holder in the longitudinal direction of the frame tube.

From the prior art there are known battery assemblies according to which the frame-side holder has two projections arranged at a distance from each other, wherein the auxiliary battery can be suspended in a projection forming a pivot axis and can be pivoted into the second projection with a locking system of the auxiliary battery.

In a comparable system, the auxiliary battery is used as the main battery. This does not necessarily require an additional drive battery.

The disadvantage of these solutions is that two projections have to be provided. Another disadvantage is the locking system to be provided on the housing of the auxiliary battery or drive battery.

It is therefore the underlying object of the invention to provide an electric bicycle and a drive battery assembly for an electric bicycle with an improved mounting which enables quick and easy mounting and removal of the drive battery or auxiliary battery.

This problem is solved by an electric bicycle having the combination of features of claim 1 and by means of a drive battery assembly for an electric bicycle according to claim 21.

The electric bicycle according to the invention has a bicycle frame and at least one drive battery assembly comprising a drive battery, wherein the drive battery has a fastening device for detachable fastening to a frame-side holder with a fastening projection. According to the invention, the receptacle of the drive battery can be brought into engagement with the fastening projection of the frame-side holder in such a manner that the drive battery can be pivoted into the frame-side holder around the fastening projection when it is mounted and can be locked by means of a latching lever. After actuating the latching lever, the drive battery can be swung out and removed. This enables the drive battery to be fitted and removed quickly and easily.

In a preferred embodiment of the invention, the electric bicycle has a bicycle frame, wherein a main battery is insertable at least in part into the bicycle frame, the drive battery being provided as an auxiliary battery. In this case, the bicycle has a main battery and an auxiliary battery.

In the following, the terms drive battery and auxiliary battery can be used interchangeably.

According to the invention, it is preferred if the latching lever automatically engages and fixes the drive battery, for example by means of a latching projection, when the drive battery is swiveled in. The drive battery can thus be applied, swiveled in and fixed with one hand. The latching lever is preferably automatically tensioned due to an inclined surface and automatically snaps into a latching recess.

It has proven to be particularly advantageous if the holder has a guide track for the receptacle of a guide projection of the drive battery. The drive battery is preferably swiveled into the guide track of the frame-side holder with the guide projection during assembly. As a result, the drive battery is securely fixed relative to the bicycle frame.

The fastening projection of the holder preferably has a head portion with an increased width compared to a shaft region.

According to a preferred embodiment of the invention, the fastening projection is cylindrically shaped and has a head portion with an enlarged diameter compared to a shaft region. Preferably, the fastening projection is approximately mushroom-shaped.

Preferably, the fastening projection has a cylindrically shaped shaft region, wherein a head portion is configured as a partial cylinder.

In an alternative embodiment of the invention, the fastening projection has a triangular cross-section at least in part.

According to an advantageous embodiment of the invention, the receptacle of the drive battery is approximately V-shaped. The opening of the V-shaped receptacle is preferably oriented towards the end section of the drive battery. This makes it particularly easy to insert and swivel the drive battery into the holder.

In the mounted state, the head portion of the fastening projection preferably engages behind a stepped shoulder of the receptacle of the drive battery. As a result, the drive battery is positively secured in this area relative to the holder.

It has proven to be particularly advantageous if the guide track is curved in an arc-shaped manner, at least in part.

The radius of curvature preferably corresponds to the distance between the guide track and the center of the fastening projection.

According to the invention, it is advantageous if the guide track is designed as an approximately U-shaped guide rail with two guide cheeks located opposite each other and connected via a central region. Preferably, the curved guide rail is arranged next to the latching lever on the side of the fastening projection.

Preferably, the guide cheeks are inclined to each other. As a result, the guide projection of the drive battery can be positively inserted laterally into the guide track and then held in such a way that it is immovable in a direction away from the holder.

In a preferred embodiment, the guide projection of the drive battery is provided with two opposing, outwardly facing cantilever projections.

In an advantageous embodiment, the latching lever is provided on the holder. It has proven to be particularly advantageous if the latching lever is provided outside the guide track in the area of a free end of the holder opposite the fastening projection.

The latching lever preferably extends transversely to a longitudinal plane of the bicycle frame.

According to one embodiment of the invention, the latching lever has a spring tongue with at least one latching member and an actuating portion.

It is particularly advantageous if the latching member of the latching lever has a latching projection that can be brought into engagement with a latching recess of the drive battery. When the latching lever, which is resiliently connected to the holder, is actuated via the actuating portion, the spring tongue moves away from the drive battery so that the latching projection is brought out of engagement with the latching recess of the drive battery. The drive battery is now unlocked and can be swiveled. This disengages the guide projection of the drive battery from the guide track of the holder. The drive battery can now be pulled out of the holder, wherein the fastening projection moves out of the receptacle of the drive battery.

In terms of production technology, it is advantageous if the latching lever is formed in one piece with the holder. The latching lever is preferably connected to the holder via a solid joint.

Two fastening recesses, preferably elongated holes, are preferably arranged between the fastening projection and the latching lever for the receptacle of one fastening screw each. The fastening points are preferably the frame-side fastening threads for a bottle holder.

According to the invention, the drive battery can be pivoted laterally into a frame triangle of the bicycle frame. In a preferred embodiment, the drive battery can be fixed to the underside of a top tube of the bicycle frame by means of the holder. According to an alternative embodiment, the drive battery can be fixed to the top of a down tube of the bicycle frame by means of the holder. In another preferred embodiment, the drive battery can be mounted on a seat tube.

The drive battery assembly according to the invention is particularly advantageous for universal mounting on bicycle frames of different designs.

A drive battery assembly for an electric bicycle according to the invention has a drive battery, wherein the drive battery has a fastening device for detachable attachment to a frame-side holder associated with the bicycle frame with a fastening projection. According to the invention, a receptacle of the drive battery can be brought into engagement with the fastening projection of the holder in such a way that the drive battery can be pivoted into the holder about the fastening projection and can be locked by means of a latching lever.

The drive battery can be provided as the sole drive battery or main battery on the bicycle. Alternatively, the drive battery is provided as an auxiliary battery in addition to a main battery arranged, for example, in the frame of the bicycle.

Further preferred embodiments are the subject-matter of the sub-claims.

In the following, preferred embodiments of the present invention are explained in more detail with reference to the accompanying drawings.:

### BRIEF DESCRIPTION OF DRAWINGS

FIG. 1 a plan view of an electric bicycle according to the invention in the area of an auxiliary battery according to a first embodiment example;

FIG. 2 a perspective view of a holder with auxiliary battery according to a further embodiment example;

FIG. 3 Another perspective view of the holder with auxiliary battery;

FIG. 4 Another perspective view of the holder with auxiliary battery;

FIG. 5 an individual representation of the holder;

FIG. 6 another individual representation of the holder;

FIG. 7 another individual representation of the holder;

FIG. 8 another individual representation of the holder;

FIG. 9 another individual representation of the holder;

FIG. 10 another individual representation of the holder;

FIG. 11 another individual representation of the holder;

FIG. 12 a representation of the auxiliary battery with holder;

FIG. 13 another representation of the auxiliary battery with holder;

FIG. 14 a representation of the auxiliary battery without holder;

FIG. 15 another illustration of the auxiliary battery without holder;

FIG. 16 another illustration of the auxiliary battery without holder;

FIG. 17 another illustration of the auxiliary battery without holder;

FIG. 18 another representation of the auxiliary battery without holder and

FIG. 19 an individual representation of an alternative holder.

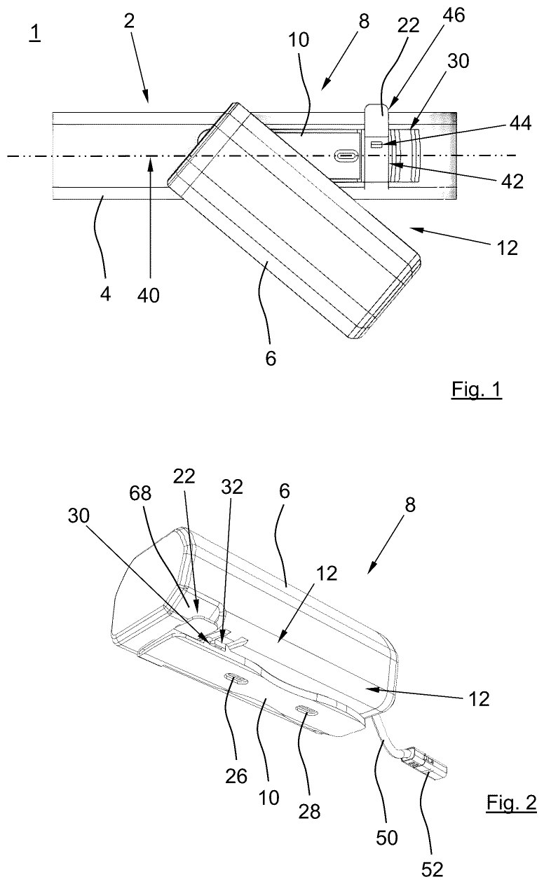

FIG. 1 shows a plan view of an electric bicycle 1 according to the invention with a schematically depicted bicycle frame 2 in the area of a top tube 4 with an auxiliary battery arrangement 8 having an auxiliary battery 6 during assembly or pivoting of the auxiliary battery 6 into a frame-side holder 10 according to a first embodiment example. In this embodiment example according to the invention, a main battery is provided in the frame and the auxiliary battery 6 is provided as an additional range extender. The auxiliary battery 6 has a fastening device 12 for detachable attachment to the frame-side holder 10.

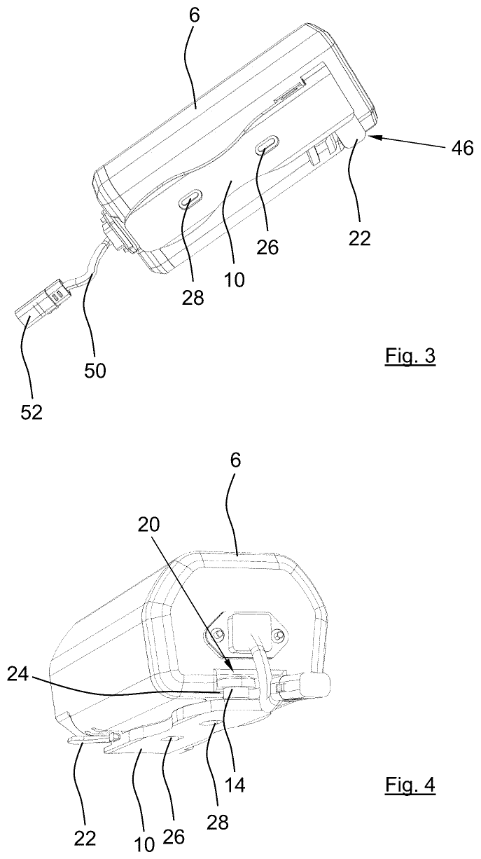

FIGS. 2 to 4 each show a perspective view of the auxiliary battery 6 swung completely into a holder 10 according to a second embodiment example and fixed there without a bicycle frame.

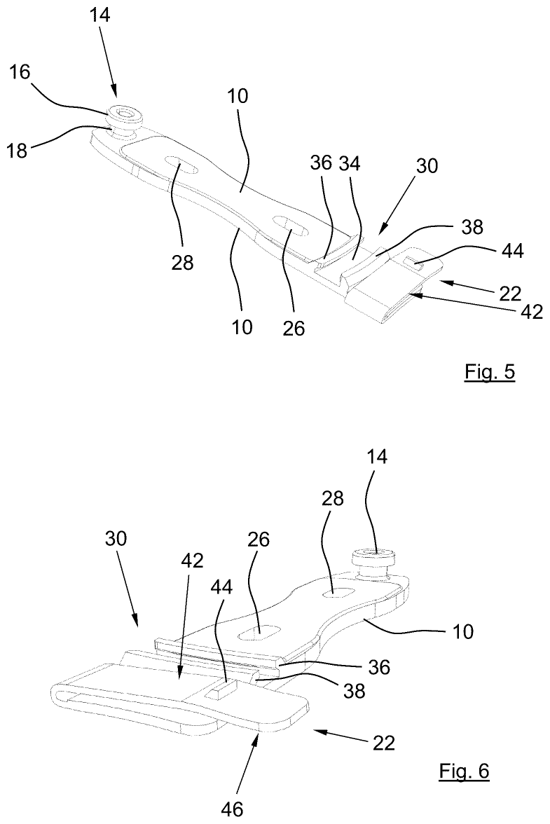

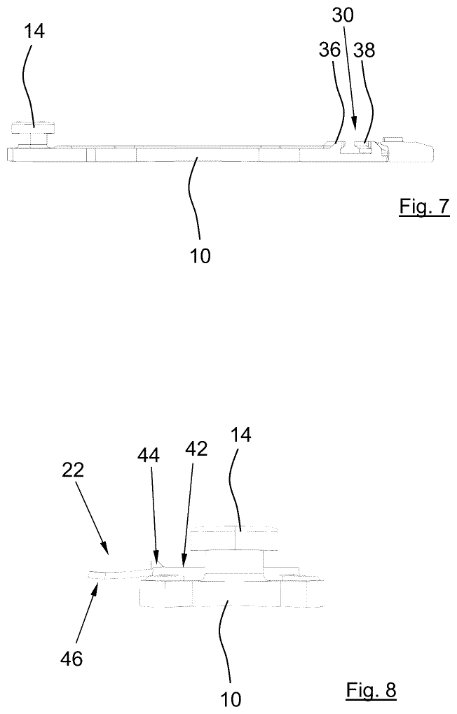

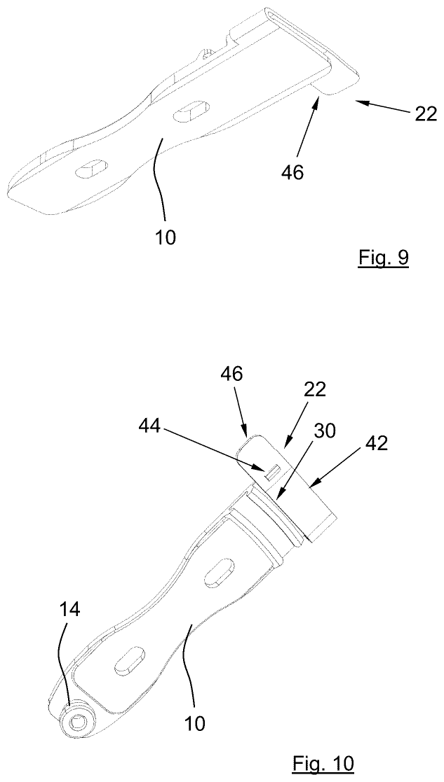

According to FIGS. 5 to 11, which show individual representations of the holder 10, the holder 10 has a fastening projection 14. The fastening projection 14 is cylindrically shaped and has a head portion 16 with an enlarged diameter compared to a shaft region 18. The fastening projection 14 is approximately T-shaped or mushroom-shaped in cross-section.

As shown in particular in FIG. 4, a receptacle 20 of the auxiliary battery 6 can be brought into engagement with the fastening projection 14 of the frame-side holder 10 in such a way that the auxiliary battery 6 can be pivoted into the frame-side holder 10 around the fastening projection 14 when it is mounted and can be locked by means of a latching lever 22. In the mounted state, the head portion 16 of the fastening projection 14 engages behind a stepped shoulder 24 of the receptacle 20 of the auxiliary battery 6. As a result, the auxiliary battery 6 is positively secured in this area relative to the holder 10. After actuating the latching lever 22, the auxiliary battery 6 can be lowered out and removed.

Two fastening recesses designed as elongated holes 26, 28 for the receptacle of a fastening screw not shown are arranged between the fastening projection 14 and the latching lever 22. The fastening points here are the frame-side fastening threads for a bottle holder. As can be seen in particular from FIGS. 5 to 11, the holder 10 has a guide track 30 for the receptacle of a guide projection 32 of the auxiliary battery 6. The guide track 30 is formed in an arc-shaped manner and extends in the transverse direction over the entire width of the holder 10. The radius of curvature corresponds to the distance of the guide track 30 from the center of the fastening projection 14. The guide track 30 is formed as an approximately U-shaped guide rail with two guide cheeks 36, 38 that are opposite one another and connected via a central region 34. The guide rail 30 is arranged next to the latching lever 22 on the side of the fastening projection 14. The guide cheeks 36, 38 are inclined relative to one another. As a result, the guide projection 32 of the auxiliary battery 6 can be positively inserted laterally into the guide track 30 and then held in such a way that it is immovable in a direction away from the holder 10.

The latching lever 22 is provided on the holder 10 outside the guide track 30 in the region of a free end of the holder 10 opposite the fastening projection 14. Alternatively, the latching lever 22 can be arranged inside the guide track 30 as shown in FIG. 1, i.e. provided on the side of the guide track 30 associated with the pivot point. The latching lever 22 is formed integrally with the holder 10. The latching lever 22 is connected to the holder 10 via an arc-shaped solid joint. The solid joint is arranged in the edge area of the holder 10. The latching lever 22 extends transversely to a longitudinal plane 40 of the bicycle frame 2 and has a spring tongue 42 with an approximately rectangular latching member provided with an inclined surface in the form of a latching projection 44 and an actuating portion 46 provided next to it. The latching member 44 is arranged on a side of the spring tongue 42 facing the auxiliary battery 6. Starting from the area of the latching projection 44, the actuating portion 46 extends outwards over the width of the holder 10 and can therefore be easily actuated.

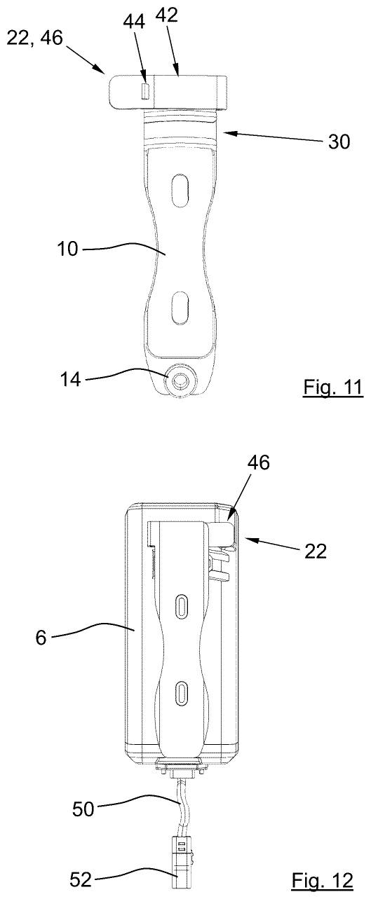

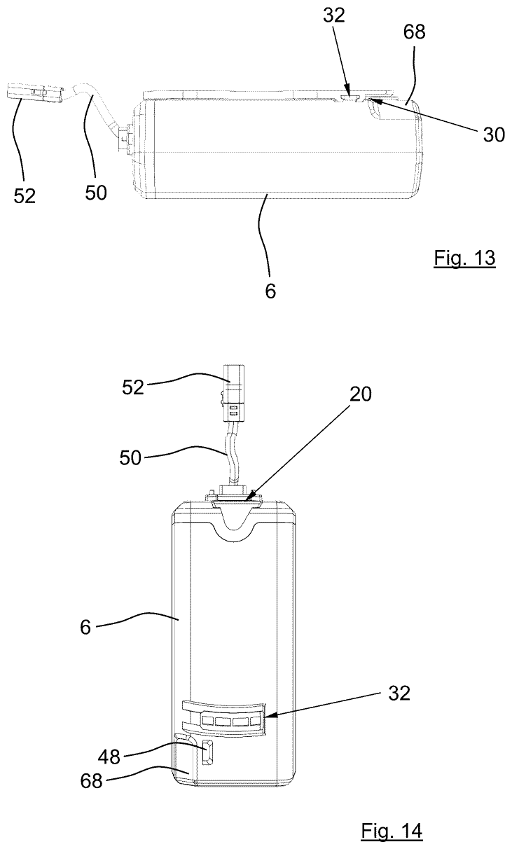

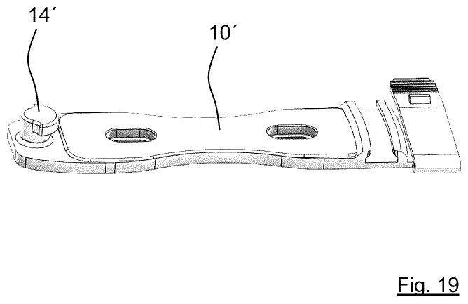

As can be seen in particular from FIGS. 12 to 18, which show the auxiliary battery 6 with holder 10 or only the auxiliary battery 6, during assembly the auxiliary battery 6 is pivoted with the guide projection 32 into the guide track 30 of the frame-side holder 10 until the latching projection 44 of the latching lever 22 of the holder 10 engages in an approximately rectangular, pocket-like latching recess 48 of the auxiliary battery 6 provided in the region of the guide track 30. The auxiliary battery 6 can be electrically connected to the bicycle via a connection cable 50 with plug connector 52.

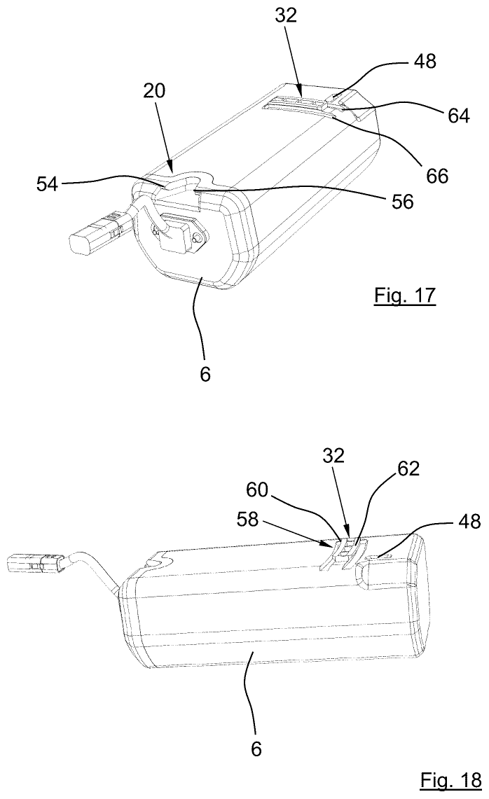

As can be seen in particular in FIG. 14, which shows a view from below of the auxiliary battery 6, and FIG. 17, which shows a perspective view of the auxiliary battery 6, the receptacle 20 for the fastening projection 14 is approximately V-shaped. The opening of the V-shaped receptacle 20 is preferably oriented towards the end section of the auxiliary battery 6. The receptacle 20 of the auxiliary battery 6 is provided with two opposing, inward-facing cantilever portions 54, 56, which form an undercut. As a result, the auxiliary battery 6 can be inserted particularly easily into the area of the fastening projection 14 of the holder 10 and then pivoted without moving away from the frame during pivoting. The auxiliary battery 6 can thus be attached, swiveled in and fixed with one hand. The latching lever 22 is automatically tensioned due to the inclined surface and snaps into the latching recess.

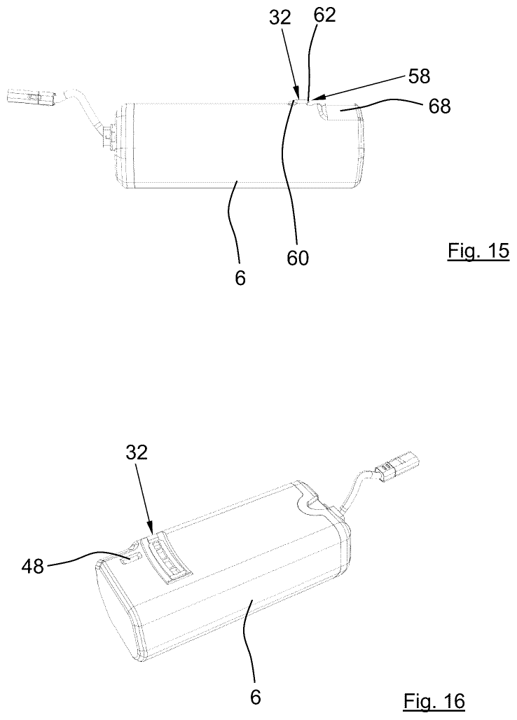

The guide projection 32 of the auxiliary battery 6 is curved in an arc-shaped manner corresponding to the guide track 30 and has a head portion 58 with two projections 60, 62 projecting in opposite directions to one another (see FIG. 15). The projections 60, 62 each have an inclined surface on the underside, which run in a V-shape to a central part. Overall, this results in an approximately T-shaped cross-section of the guide projection 32. Two correspondingly arc-shaped grooves 64, 66 extending parallel to one another are provided below the projecting projections 60, 62. A first end section of the grooves 64, 66 is flush with the guide projection 32. The second ends of the grooves 64, 66 extend into an edge region of the auxiliary battery 6.

According to FIG. 19, which shows a variant of the holder 10, the fastening projection 14 in this alternative embodiment example has an approximately triangular head portion that is at least partially cylindrical in part. Here, the wider side of the head portion faces the guide track

The disassembly or removal of the auxiliary battery 6 is explained below. For this purpose, the latching lever 22, which is resiliently connected to the holder 10, is actuated in the direction of the bicycle frame via the actuating portion 46, wherein the spring tongue 42 moves away from the auxiliary battery 6 so that the latching projection 44 of the latching lever 22 is disengaged from the latching recess 48 of the auxiliary battery 6. To facilitate actuation of the latching lever 22, a notch 68 is provided on the auxiliary battery 6 in the area of the latching lever 22. The auxiliary battery 6 is unlocked and can be pivoted. As a result, the guide projection 32 of the auxiliary battery 6 is disengaged from the guide track 30 of the holder 10. The auxiliary battery 6 can now be pulled out of the holder 10, wherein the fastening projection 14 moves out of the receptacle 20 of the auxiliary battery 6, so that the latter is completely released.

Disclosed is an electric bicycle 1 comprising a bicycle frame 2 and a drive battery assembly 8 having at least one drive battery 6, wherein the drive battery 6 has a fastening device 12 for detachable fastening to a frame-side holder 10 with fastening projection 14. According to the invention, a receptacle 20 of the drive battery 6 can be brought into engagement with the fastening projection 14 of the frame-side holder 10 in such a manner that the drive battery 6 can be pivoted into the holder 10 about the fastening projection 14 and can be locked by means of a latching lever 22. Also disclosed is a drive battery assembly 8 for an electric bicycle 1.

### LIST OF REFERENCE SIGNS

1 electric bicycle
2 bicycle frame
4 top tube
6 auxiliary battery/drive battery
8 drive battery assembly
10 holder
12 fastening device
14 fastening projection
16 head portion
18 shaft region
20 receptacle
22 latching lever
24 stepped shoulder
26 elongated hole
28 elongated hole
30 guide track
32 guide projection
34 central region
36 guide cheek
38 guide cheek
40 longitudinal plane
42 spring tongue
44 latching projection
46 actuating portion
48 latching recess
50 connection cable
52 plug connector
54 cantilever portion
56 cantilever portion
58 head portion
60 projection
62 projection
64 groove
66 groove
68 notch

1. An electric bicycle (1) comprising a bicycle frame (2) and at least one battery assembly (8) having a drive battery (6), wherein the drive battery (6) comprises a fastening device (12) for detachable fastening to a frame-side holder (10) with a fastening projection (14), characterized in that a receptacle (20) of the drive battery (6) can be brought into engagement with the fastening projection (14) of the holder (10) in such a manner that the drive battery (6) can be pivoted into the holder (10) about the fastening projection (14) and can be locked by means of a latching lever (22).

2. The electric bicycle according to claim 1, wherein the holder (10) comprises a guide track (30) for receiving a guide projection (32) of the drive battery (6).

3. The electric bicycle according to claim 1, wherein the fastening projection (14) of the holder (10) has a head portion (16) with an increased width compared to a shaft region (18).

4. The electric bicycle according to claim 1, wherein the fastening projection (14) is cylindrically shaped and comprises a head portion (16) with an enlarged diameter compared to a shaft region (18).

5. The electric bicycle according to claim 1, wherein the fastening projection (14) comprises a cylindrically shaped shaft region (18) and a head portion is configured as a partial cylinder.

6. The electric bicycle according to claim 1, wherein the fastening projection (14) has a triangular cross-section at least in part.

7. The electric bicycle according to claim 1, wherein the receptacle (20) of the drive battery (6) in plan view from above is approximately V-shaped.

8. The electric bicycle according to claim 1, wherein the fastening projection (14) in the mounted state engages behind a stepped shoulder (24) of the receptacle (20) of the drive battery (6).

9. The electric bicycle according to claim 2, wherein the guide track (30) is curved in an arc-shaped manner at least in part.

10. The electric bicycle according to claim 9, wherein the radius of curvature corresponds to the distance of the guide track (30) to the center of the fastening projection (14).

11. The electric bicycle according to claim 2, wherein the guide track (30) is configured as an approximately U-shaped guide rail with two guide cheeks (36, 38) lying opposite each other and connected via a central region (34).

12. The electric bicycle according to claim 11, wherein the guide cheeks (36, 38) are inclined relative to one another.

13. The electric bicycle according to claim 1, wherein the guide projection (32) of the drive battery (6) comprises two opposing, outwardly facing projections (60, 62).

14. The electric bicycle according to claim 1, wherein the latching lever (22) is provided on the holder (10).

15. The electric bicycle according to claim 1, wherein the latching lever (22) extends transversely to a longitudinal plane (40) of the bicycle frame (2).

16. The electric bicycle according to claim 1, wherein the latching lever (22) comprises a spring tongue (42) with at least one latching member (44) and an actuating portion (46).

17. The electric bicycle according to claim 16, wherein the latching member of the latching lever (22) has a latching projection (44) which can be brought into engagement with a latching recess (48) of the drive battery (6).

18. The electric bicycle according to claim 1, wherein the latching lever (22) is integrally formed with the holder (10).

19. The electric bicycle according to claim 1, wherein the drive battery (6) can be pivoted laterally into a frame triangle of the bicycle frame (2).

20. The electric bicycle according to claim 1, with a main battery arranged in the bicycle frame (2) at least in part, wherein the drive battery is an auxiliary battery (6).

21. A drive battery assembly for an electric bicycle (1) comprising at least one drive battery (6), wherein the drive battery (6) comprises a fastening device (12) for detachable fastening to a frame-side holder (10) associated with the bicycle frame (2) and having a fastening projection (14), characterized in that a receptacle (22) of the drive battery (6) can be brought into engagement with the fastening projection (14) of the holder (10) in such a manner that the drive battery (6) can be pivoted into the holder (10) about the fastening projection (14) and can be locked by means of a latching lever (22).

22. The drive battery assembly for an electric bicycle (1), having a main battery arranged in the bicycle frame (2) at least in part, the drive battery being an auxiliary battery (6).
